(19) United States
(12) Patent Application Publication
(10) Pub. No.: US 2013/0278676 A1
(43) Pub. Date: Oct. 24, 2013

(54) PRINTER DEVICE AND MAINTENANCE METHOD THEREOF

(71) Applicant: MIMAKI ENGINEERING CO., LTD., Nagano (JP)

(72) Inventor: Hirofumi HARA, Nagano (JP)

(21) Appl. No.: 13/921,190

(22) Filed: Jun. 18, 2013

Related U.S. Application Data
(62) Division of application No. 13/147,803, filed on Aug. 3, 2011.

(30) Foreign Application Priority Data
Feb. 19, 2009 (JP) 2009-036557

(51) Int. Cl. B41J 19/20

(52) U.S. Cl. CPC B41J 19/202
USPC 347/39

(57) ABSTRACT

A printer device which can, using a relatively simple structure, remove foreign matter within a printer head. A printer device (10) is provided with: a guide rail disposed so as to extend in the scan direction; a printer head (22) provided to the guide rail so as to be reciprocatable in the scan direction and discharging ink from a discharge nozzle (25a) by changing, utilizing the vibration of a piezo element (24), the volume of an ink chamber (24a) communicating with the discharge nozzle (25a); and a controller performs control for vibrating the piezo element (24) and maintains the printer head (22) by causing the ink to be discharged utilizing the vibration of the piezo element (24).

### CROSS-REFERENCE TO RELATED APPLICATION

This application is a divisional application of and claims the priority benefit of U.S. application Ser. No. 13/147,803, filed on Aug. 3, 2011, which is a 371 application of an international PCT application serial no. PCT/JP2010/000413, filed on Jan. 26, 2010, which claims the priority benefit of Japan application serial no. 2009-036557, filed on Feb. 19, 2009. The entirety of the above-mentioned patent applications is hereby incorporated by reference herein and made a part of this specification.

### TECHNICAL FIELD

The present invention relates to a printer device that performs printing by discharging an ink from a printer head and a maintenance method for maintaining the printer head.

### BACKGROUND ART

In printer devices (inkjet printers), printing is typically performed by adhering an ink to a printing medium in a predetermined pattern by discharging the ink from discharge nozzles arranged on a bottom surface of a printer head while causing the printer head to move relative to the printing medium. The ink is discharged in the form of minute droplets and a desired printing is performed by superimposing and adhering the discharged ink to a surface of the printing medium. Recently, a printer head has been developed in which the ink is discharged from the discharge nozzles communicating with an ink chamber by changing a capacity of the ink chamber by causing an oscillating element, such as a piezo element, to oscillate. For example, in FIG. 2 shown in Patent Document 1, a configuration is disclosed in which an ink is discharged from a nozzle opening 51 by causing pressure variation in the ink filled in an ink chamber 71 by expanding or contracting a piezoelectric oscillator 6 that functions as the oscillating element.

The openings of the discharge nozzles are made extremely small to allow discharging the ink in the form of minute droplets. If the ink is discharged from the discharge nozzles while foreign substances and air bubbles are adhering to an inner surface of the discharge nozzles, the ink cannot be properly discharged of the discharge nozzles and it becomes difficult to perform the desired printing. Therefore, a maintenance unit is mounted in the conventional printer device to recover the ink so as to enable proper discharge of the ink from the discharge nozzles. For example, in a state in which the discharge nozzles are covered with a cap member, which is arranged inside the maintenance unit, an inside of the cap is set to a negative pressure and the ink in the printer head (ink chamber) is sucked into the cap side, and along with the sucked ink, the foreign substances and the air bubbles are sucked and removed. By performing such an ink suction operation each time after performing printing for a predetermined period, it is possible to maintain a state in which the ink can always be discharged normally.

### RELATED PRIOR ART LIST

### Patent Literature

Patent Document 1: Japanese Patent Application Laid-open No. 2001-105613

### DISCLOSURE OF INVENTION

### PROBLEM TO BE SOLVED BY THE INVENTION

In the above-explained method for removing the foreign substances, etc., the ink inside the printer head is simply sucked into the cap side, and the foreign substances, etc., are sucked along with the sucked ink and removed without oscillating the oscillating element as it is done while performing printing. Therefore, the foreign substances, etc., that comparatively strongly adhere inside the discharge nozzles or the oscillating element are not likely to be removed by this method. Consequently, the ink cannot be discharged as desired from the discharge nozzles, or the ink is discharged in a curved trajectory towards the printing medium instead of a straight trajectory. The ink thus cannot be deposited in a desired pattern on a target position.

The present invention is made in view of the above discussion and it is an object of the present invention to provide a printer device capable of removing the foreign substances, etc., from inside of the printer head even with a relatively simple configuration, and a maintenance method for the printer device.

### MEANS FOR SOLVING PROBLEMS

To achieve the above object, a printer device according to the present invention includes an ink tank that stores therein an ink, a guide rail that faces a medium supporting unit (for example, a platen 12a according to embodiments) that supports a printing medium (for example, a printing sheet M according to embodiments), and that moves relative to the printing medium supported by the medium supporting unit in a predetermined conveying direction, and extends in a scanning direction orthogonal to the predetermined conveying direction; a printer head that is reciprocatable relative to the guide rail in the scanning direction, and that discharges an ink from a nozzle opening (for example, a discharge nozzles 25a according to embodiments) that is open in a downward direction, by changing a capacity of an ink chamber, which communicates with the nozzle opening, by oscillation of an oscillating element (for example, a piezo element 24 according to embodiments); and a drive control unit (for example, a controller 13b according to embodiments) that controls the oscillation of the oscillating element and drive-controls the supply pump. The drive control unit exerts control to oscillate the oscillating element and performs maintenance of the printer head by causing the ink to be discharged by the oscillation of the oscillating element.

The printer device further includes a receiving member (for example, cap members 45 according to embodiments) arranged near an end portion of the guide rail in the scanning direction to receive the ink discharged from the nozzle opening. The drive control unit exerts control to oscillate the oscillating element and performs maintenance of the printer head by causing the ink to be discharged by the oscillation of the oscillating element in a state in which the printer head is moved to the end portion of the guide rail in the scanning direction and the nozzle opening is positioned facing the receiving member with a gap therebetween. Specifically, the drive control unit, after performing a first maintenance operation in which the drive control unit drive-controls the supply pump and controls the oscillating element to oscillate, performs a second maintenance operation in which the drive control unit drive-controls the supply pump to stop and controls the oscillating element to oscillate during maintenance of the printer head during the maintenance of the print head.

The printer device further includes an ink supply channel (for example, a supply tube 52 according to embodiments) via which the ink chamber is connected to an ink tank (for example, an ink cartridge 51 according to embodiments) that stores therein an ink; and a supply pump arranged in the ink supply channel to supply the ink stored in the ink tank to the ink chamber. The drive control unit drive-controls the supply pump. During maintenance of the printer head, the drive control unit exerts control to drive the supply pump continuously. In one embodiment of the invention, a time for continuously performing the first maintenance operation can be 2 minutes or more, and a time for continuously performing the second maintenance operation can be 10 minutes or more.

The printer device further including an ink supply channel via which the ink chamber is connected to an ink tank that stores therein an ink; and a supply pump arranged in the ink supply channel to supply the ink stored in the ink tank to the ink chamber. The drive control unit drive-controls the supply pump. During maintenance of the printer head, the drive control unit controls the oscillation of the oscillating element and drive-controls the supply pump. Specifically, the drive control unit performs the second maintenance operation after performing the first maintenance operation in a state in which the printer head is moved to the end portion of the guide rail in the scanning direction and the nozzle opening is positioned facing the receiving member with a gap therebetween to form a meniscus in the nozzle opening.

A maintenance method for performing maintenance of a printer head that is arranged so as to be reciprocatable along a guide rail, and that discharges an ink from a nozzle opening that is open in a downward direction, by changing a capacity of an ink chamber, which communicates with the nozzle opening, by oscillation of an oscillating element. The maintenance method includes a first step of moving the printer head near an end portion of the guide rail and positioning the nozzle opening facing a receiving member that is arranged near an end portion of the guide rail for receiving the ink discharged from the nozzle opening, with a gap therebetween, so as to form a meniscus in the nozzle opening; a second step of drive-controlling the supply pump supplying ink to the ink chamber and controlling the oscillating element to oscillate such that the ink is discharged from the nozzle opening after the first step is performed; and a third step of controlling the oscillating element to oscillate such that the ink is discharged from the nozzle opening in a state in which the supply pump is stopped after the second step is performed.

### ADVANTAGES OF THE INVENTION

In a printer device according to the present invention, a drive control unit controls oscillation of an oscillating element and performs maintenance of a printer head causing an ink to be discharged by the oscillation of the oscillating element. With this configuration, foreign substances, etc., adhering inside a film member (for example, oscillating element) that is flexible and that forms an ink chamber can be easily separated by the oscillation of the oscillating element. Therefore, the foreign substances, etc., inside the printer head can be reliably removed even with a relatively simple configuration in which the oscillation control to be exerted on the oscillating element is partially changed without adding a new structural component as compared to a conventional configuration.

It is desirable to perform maintenance of the printer head by causing the ink to be discharged by the oscillation of the oscillating element in a state in which a nozzle opening is positioned facing a receiving member with a gap therebetween. With this configuration, the ink, the foreign substances, etc., discharged during maintenance can be efficiently received and collected in the receiving member without allowing them to scatter in a surrounding area. During this operation, because there is a gap between the nozzle opening and the receiving member, the ink discharged during maintenance is discharged in the air. Thus, a meniscus can be easily formed in the nozzle opening as compared to a case in which, for example, the nozzle opening is covered by the receiving member.

During maintenance of the printer head, the drive control unit should preferably exert control to drive a supply pump continuously. When such a control is exerted, the foreign substances, etc., that are separated by the oscillation of the oscillating element, can be discharged along with the ink and thus reliably removed.

On the other hand, during maintenance of the printer head, the drive control unit can exert control to stop driving the supply pump. In this configuration, because an amount of ink consumed during maintenance can be reduced, a running cost of the printer device can be reduced.

A maintenance method according to the present invention includes the following steps; (1) positioning the nozzle opening facing the receiving member with a gap therebetween; and (2) performing maintenance of the printer head by causing the ink to be discharged by the oscillation of the oscillating element. With this configuration, the foreign substances, etc., adhering inside the oscillating element that forms the ink chamber are separated by the oscillation of the oscillating element, and the ink, the foreign substances, etc., discharged during maintenance can be efficiently received and collected in the receiving member without allowing them to scatter in the surrounding area.

### BRIEF DESCRIPTION OF DRAWINGS

FIG. 1 is a front view of a printer device to which the present invention is applied.

FIG. 2 is a perspective view of a head unit and surrounding components thereof in the printer device.

FIG. 3 is a cross sectional view of a status of the printer head for which a maintenance operation is performed.

FIG. 4 is a control system diagram of the printer device.

FIG. 5 is a table showing operating conditions of components during the maintenance operation.

FIG. 6 is a table showing the number of printer heads recovered during a conventional maintenance operation and a maintenance operation according to the present invention.

### EMBODIMENT(S) OF THE INVENTION

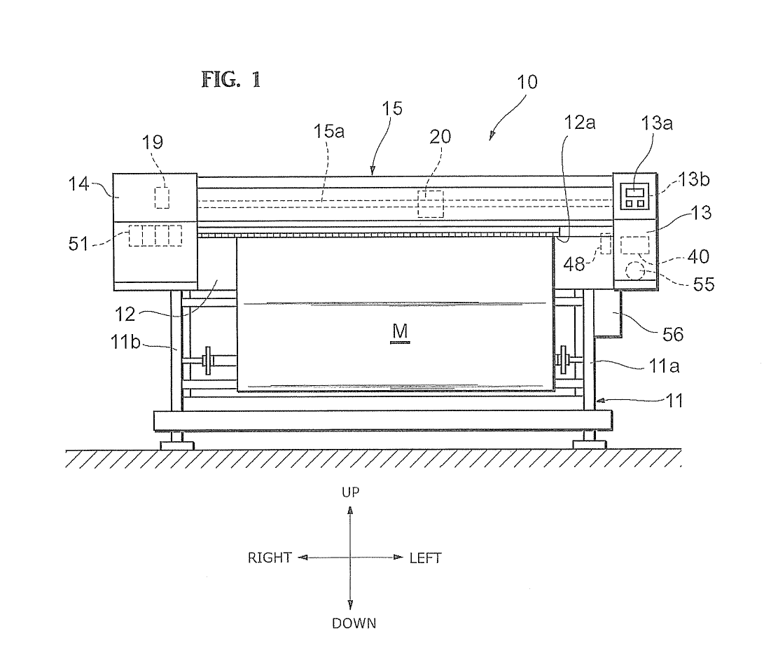

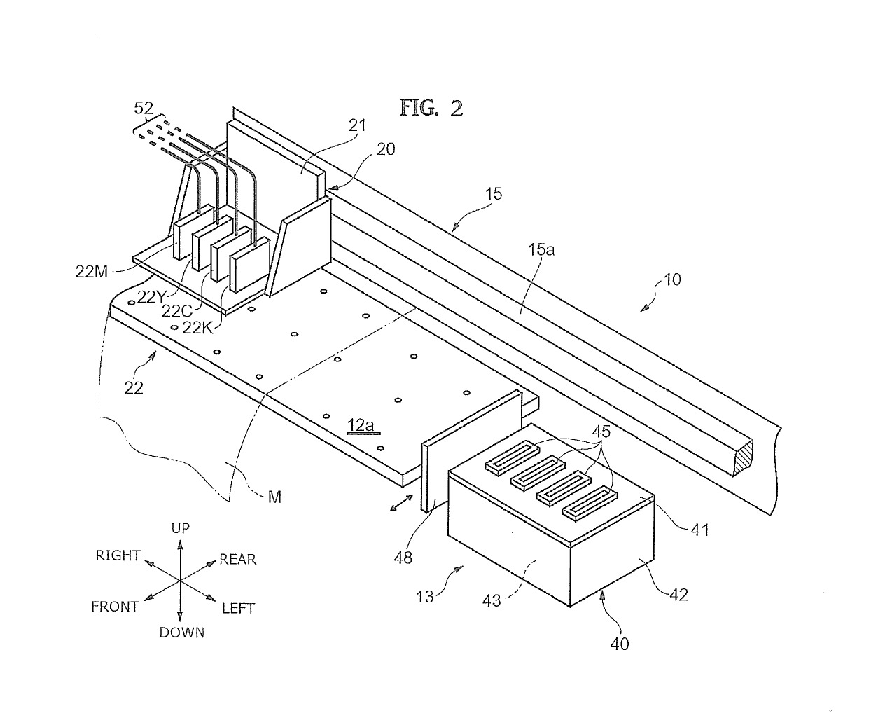

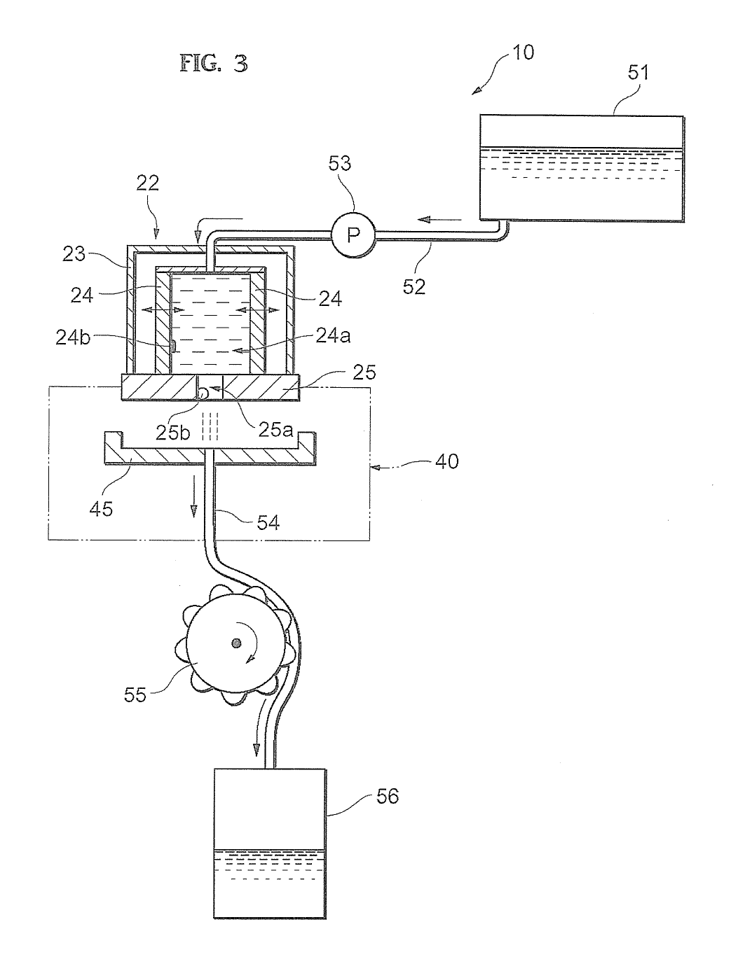

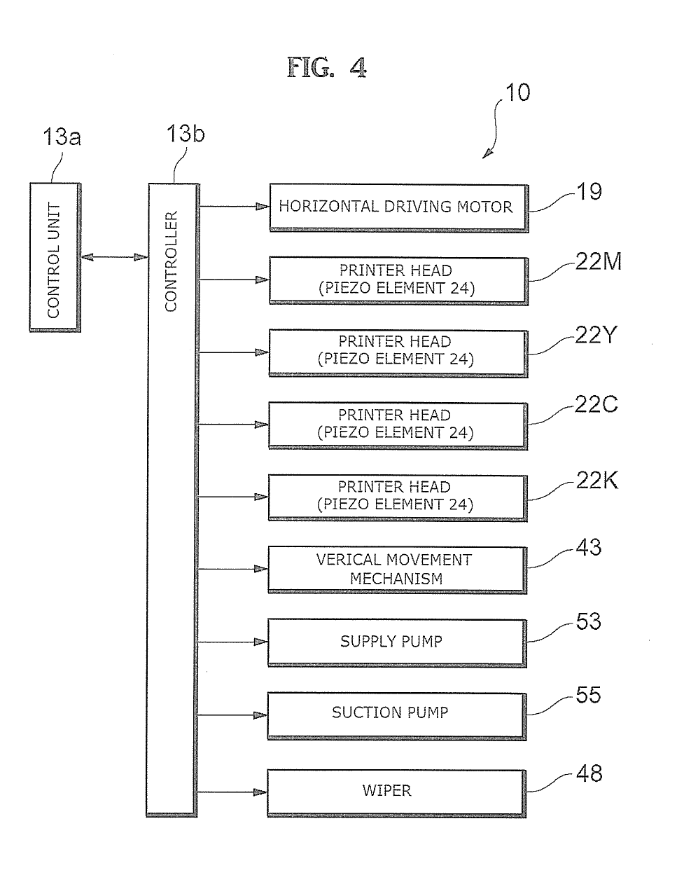

Exemplary embodiments of the present invention are explained in detail below with reference to the accompanying drawings. For the sake of simplicity, an explanation will be given with the help of arrow directions that are shown in the drawings and are defined as front-back, left-right, and up-down. A configuration of a printer device 10 to which the present invention is applied is explained first with reference to FIGS. 1 to 4. FIG. 1 is a front view of the printer device 10; FIG. 2 is a perspective view of a head unit 20 that is described later and surrounding components thereof; FIG. 3 is a cross sectional view of a status of a printer head 22 for which a maintenance operation is performed; and FIG. 4 is a control system diagram of the printer device 10.

As shown in FIG. 1, the printer device 10 includes a supporting frame 11 that includes a left supporting leg 11a and a right supporting leg 11b, a central body 12 that is supported by the supporting frame 11, a left body 13 that is arranged on the left side of the central body 12, a right body 14 that is arranged on the right side of the central body 12, and an upper body 15 that is arranged above and parallel to the central body 12 with a gap therebetween, and that extends across connecting the left body 13 and the right body 14. A platen 12a that extends across horizontally is arranged in the central body 12, and is exposed to an upper surface thereof.

An operating unit 13a that includes operating switches, display panels, etc., is arranged on the front surface of the left body 13 and a controller 13b is arranged inside the left body 13. The controller 13b receives operation signals from the operating unit 13a, outputs the operation signals to structural components of the printer device 10, and controls operations of the structural components. Specifically, as shown in FIG. 4, the controller 13b outputs the operation signals to a horizontal driving motor 19 that is described later, printer heads (piezo elements 24) 22M, 22Y, 22C, and 22K, a vertical movement mechanism 43, a supply pump 53, a suction pump 55, a wiper 48, etc. Furthermore, a maintenance unit 40 is arranged on the left side of the platen 12a inside the left body 13. A configuration of the maintenance unit 40 is explained later.

As shown in FIG. 2, a guide rail 15a that extends across horizontally is arranged inside the upper body 15 and the head unit 20 is fixed such that it is horizontally reciprocatable along the guide rail 15a. A printing sheet M that is a printing target, after being sandwiched between a clamp device (not shown) arranged on a lower portion of the upper body 15 and a feed roller (not shown) that is exposed to the platen 12a, can be moved forward and backward by a predetermined distance by causing the feed roller to rotate.

The head unit 20 primarily includes a carriage 21 and the printer head 22. A back surface of the carriage 21 is fitted to the guide rail 15a; therefore the carriage 21 can reciprocate horizontally along the guide rail 15a. The carriage 21 reciprocates horizontally by the horizontal driving motor 19 arranged inside the right body 14 (see FIG. 1). The printer head 22 includes, for example, the printer heads 22M, 22Y, 22C, and 22K of magenta (M), yellow (Y), cyan (C), and black (K) color, respectively, and is mounted on the carriage 21. The printer heads 22M, 22Y, 22C, and 22K have substantially the same configuration. In FIG. 3, a cross sectional view of any one of the printer heads 22M, 22Y, 22C, and 22K is shown. In FIG. 3, only main components of the printer head 22 are schematically shown.

As can be understood from FIG. 3, which is the cross-sectional view of the printer head 22, the printer head 22 primarily includes a casing member 23 that covers sides and an upper side of the printer head 22, piezo elements 24, 24 that function as oscillating elements, and a nozzle plate 25 that forms a bottom surface of the printer head 22. The nozzle plate 25 is, for example, a plate-like material with a plurality of discharge nozzles 25a formed thereon that vertically penetrates through it. The piezo element 24 is one of the types of piezoelectric elements that oscillate by converting an applied voltage into a force. The piezo element 24 oscillates horizontally in a state shown in FIG. 3 by application of the voltage that is based on the operation signals output from the controller 13b.

With the structure described above, by causing the piezo element 24 to oscillate, a capacity of an ink chamber 24a, which is enclosed by the piezo elements 24, 24, can be changed and an ink filled inside the ink chamber 24a can be downwardly discharged from the discharge nozzles 25a. The ink chamber 24a is formed for each of the discharge nozzles 25a. Therefore, discharge of the ink from each of the discharge nozzles 25a can be independently controlled.

The printer head 22 is connected to an ink cartridge 51, which is detachably attached to a back surface of the right body 14, via a supply tube 52 (see FIGS. 1 and 3). As shown in FIG. 3, the ink stored in the ink cartridge 51 is supplied to the ink chamber 24a by driving the supply pump 53 that is arranged in the supply tube 52. The supply pump 53 is drive-controlled based on the operation signals output from the controller 13b.

As shown in FIG. 2, the maintenance unit 40 primarily includes a base plate 41 with cap members 45 arranged thereon and a unit body 42 that internally includes the vertical movement mechanism 43 that can vertically move the base plate 41. Four cap members 45 that are horizontally arranged corresponding to each printer head 22 and a shape of the nozzle plate 25 are fixed on the base plate 41. The base plate 41 is movable vertically relative to the unit body 42 by the vertical movement mechanism 43. As shown in FIG. 3, one end of a discharge tube 54 is connected to a bottom of each of the cap members 45 and the other end is connected to a waste ink tank 56. The suction pump 55 that is formed of, for example, a tube pump is arranged in the middle of the discharge tube 54.

With this structure, for example, during a standby time in which printing is not performed, the head unit 20 is positioned over the maintenance unit 40 and the bottom surface of the printer head 22 is covered by moving the cap member 45 upwardly with the vertical movement mechanism 43. Thus, thickening of the ink filled in the ink chamber 24a and the discharge nozzles 25a can be prevented from occurring.

The wiper 48 made of a resin material, such as rubber, is mounted between the maintenance unit 40 and the platen 12a (see FIG. 2) such that it can be moved forward and backward. In FIG. 2, a state of the wiper 48 that is at a backward position is shown. The wiper 48 is always at a forward position (not shown). When the wiper 48 is at the backward position, by horizontally moving the head unit 20, the bottom surface of the printer head 22 abuts against (simulating a wiping action) the upper portion of the wiper 48. By the abutting of the bottom surface of the printer head 22 against the upper portion of the wiper 48, the foreign substances adhering to the bottom surface of the printer head 22 can be removed. Furthermore, a meniscus can be easily formed in the discharge nozzle 25a by the wiping action.

The configuration of the printer device 10 is explained so far. Operations that are performed during printing on the printing sheet M using the printer device 10 are explained next.

The printing starts when the operating unit 13a is operated by an operator and the ink is discharged from the discharge nozzles 25a in a downward direction by oscillating the piezo element 24 while horizontally reciprocating the printer head 22 along the guide rail 15a against the printing sheet M positioned on the platen 12a. As a result, the printing is performed on the surface of the printing sheet M by adhering the ink in a desired pattern. The ink is adhered to the printing sheet M while horizontally reciprocating the carriage 21 again after the printing sheet M is moved by the predetermined distance with a rotation of the feed roller. By repeatedly performing the above operation, the printed printing sheet M is wound into a roll form on a front side of the printer device 10.

If printing is performed continuously while performing the operation described above, there is a likelihood that the foreign substances such as dust will adhere to a bottom surface of the printer head 22. Thus, if printing is performed with the foreign substances adhering to the bottom surface of the printer head 22, the ink is not discharged straight in the downward direction and a printing quality is likely to deteriorate. Thus, after performing printing for a certain time, the wiper 48 is made to abut against the bottom surface of the printer head 22 by periodically moving the head unit 20 over the wiper 48, and the foreign substances are removed.

The foreign substances such as a thickened ink, dust, or air (air bubbles) are likely to be pushed into the discharge nozzles 25a or the ink chamber 24a by making the wiper 48 abut against the bottom surface of the printer head 22 as described above (FIG. 3). If printing is performed by discharging the ink with such foreign substances remaining in the discharge nozzles 25a and the ink chamber 24a, no ink is discharged from the discharge nozzles 25a because the discharge nozzles 25a are blocked by foreign substances 24b. Even if any ink is discharged from the discharge nozzles 25a, it is not discharged straight in the downward direction because the flow of the ink is obstructed by air bubbles 25b. To prevent the above from happening, in the printer device 10 according to the present invention, a first maintenance operation that is described later is performed after performing the printing for a predetermined period.

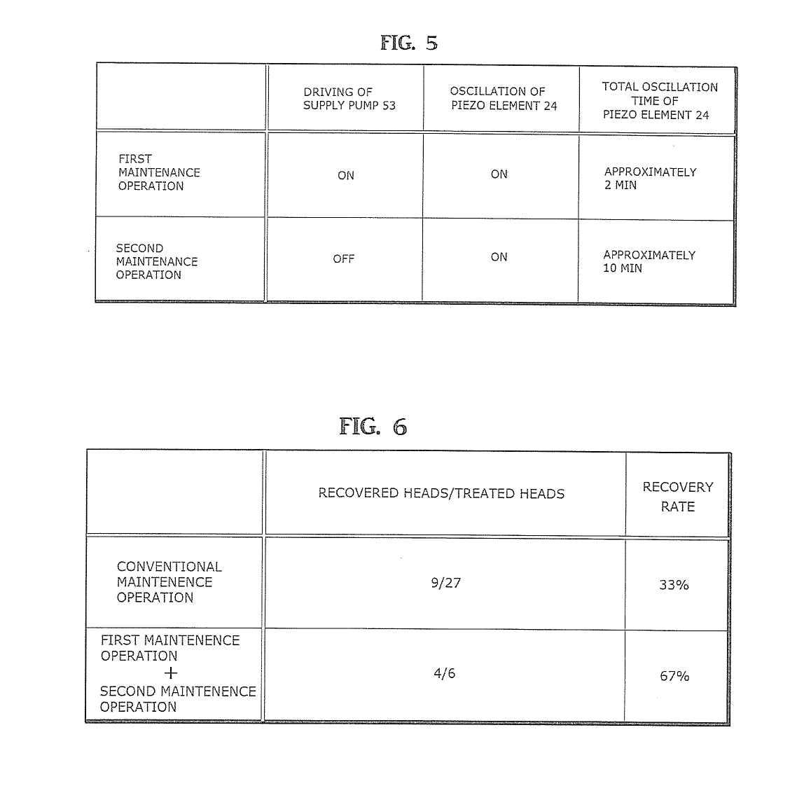

When performing the first maintenance operation, first, the head unit 20 is moved over the maintenance unit 40. Thereafter, as shown in FIG. 3, the nozzle plate 25 and the cap member 45 are caused to vertically face each other by maintaining a gap therebetween without covering the bottom surface of the printer head 22 (nozzle plate 25) by the cap member 45. In this state, the piezo element 24 is oscillated at a time interval of, for example, approximately 80 microseconds (μsec) (80×10⁻⁶ seconds) while forcefully supplying the ink to the ink chamber 24a by driving the supply pump 53 (see first stage in FIG. 5). A plurality of ink chambers 24a of the printer head 22 is divided into, for example, three groups and the first maintenance operation is continuously performed for, for example, approximately 2 minutes while oscillating the piezo element 24 for each group at the time interval of approximately 80 μsec.

Thus, a meniscus with a high precision can be formed in the discharge nozzles 25a as compared to a case in which the first maintenance operation is performed in a state in which the bottom surface of the printer head 22 is covered by the cap member 45. Thus, a frequency of cleaning the bottom surface of the printer head 22 using the wiper 48 and performing the first maintenance operation can be reduced.

An oscillation amplitude of the piezo element 24 during the first maintenance operation is set such that it is nearly equal to that by which, for example, the smallest ink droplet is discharged from the printer head 22. The discharge of the smallest ink droplet is explained assuming that the configuration of the printer device 10 can be set to three printing resolutions of, for example, 300 dots per inch (dpi), 600 dpi, and 1200 dpi. When the printer device is set to the printing resolution of 1200 dpi, as compared to a case in which the printer device 10 is set to another printing resolution, a smaller ink droplet is discharged and a fine printing is performed. If the size of the ink droplet in case of 1200 dpi is considered as a reference, in case of 600 dpi, the piezo element 24 is oscillated to a significant degree, so as to discharge an ink droplet that is, for example, four times (equivalent to four droplets) the size of the reference ink droplet. Furthermore, in case of 300 dpi, the piezo element 24 is oscillated to a further significant degree, so as to perform printing by discharging an ink droplet that is, for example, seven times (equivalent to seven droplets) the size of the reference ink droplet. In case of the configuration described above, the oscillation amplitude of the piezo element 24 is set to an oscillation amplitude by which the ink droplet for 1200 dpi is discharged.

Thus, by oscillating the piezo element 24, the foreign substance 24b adhering inside the piezo element 24 is oscillated horizontally and it can be separated comparatively easily from the piezo element 24. The separated foreign substance 24b is discharged along with the ink in the ink chamber 24a flowing towards the discharge nozzles 25a, and received in the cap member 45. The discharged ink and the foreign substance 24b can be stored in the waste ink tank 56 via the discharge tube 54 by operating the suction pump 55 during the first maintenance operation. The air bubbles 25b near the discharge nozzles 25a can be discharged along with the ink flowing towards the discharge nozzles 25a from the ink chamber 24a and removed.

A second maintenance operation can be performed instead of the first maintenance operation. In the second maintenance operation, as shown in a second stage of FIG. 5, the piezo element 24 is caused to oscillate similarly as described above, in a state in which driving of the supply pump 53 is stopped. Similar to the first maintenance operation, the second maintenance operation is performed in a state in which a gap is maintained between the cap member 45 and the bottom surface of the printer head 22 (nozzle plate 25) without covering the bottom surface of the printer head 22 by the cap member 45 (see FIG. 3).

By continuously performing the second maintenance operation for, for example, approximately 10 minutes, the foreign substance 24b can be separated from the piezo element 24 by horizontally oscillating the foreign substance 24b adhering inside the piezo element 24. The separated foreign substance 24b is discharged along with the ink from the discharge nozzle 25a, and received in the cap member 45. Thus, in the second maintenance operation, because the supply pump 53 is stopped, an amount of ink consumed during the maintenance can be reduced, and a running cost of the printer device 10 can be reduced.

A printer head (for example, Part No. CA4, etc., manufactured by Toshiba Tec Corporation) in which a discharge defect has occurred is collected in plurality and various maintenance operations are performed for these printer heads. In FIG. 6, test results, which are obtained after the maintenance operations, indicating to what extent the discharge defects can be recovered are shown. A first stage of FIG. 6 shows a test result of a case in which a conventional maintenance operation is performed. In the conventional maintenance operation, the supply pump 53 and the suction pump 55 are driven in a state in which the bottom surface of the printer head 22 is covered by the cap member 45 without driving the piezo 24. The first stage shows that discharge defects of only 9 (33%) out of 27 printer heads can be recovered.

On the other hand, a second stage of FIG. 6 shows a test result of a case in which the first maintenance operation is performed first for the printer heads and subsequently the second maintenance operation is performed for the discharge defects that are not recovered in the first maintenance operation. The second stage shows that the discharge defects of 4 (67%) out of 6 printer heads can be recovered. As can be surmised from the above results, by performing the maintenance operation using the printer device 10 to which the present invention is applied, the discharge defects of the printer head 22 can be recovered with a higher probability than the conventional maintenance operation.

Therefore, even if the discharge defects occur, they can be recovered with a high probability by performing the first maintenance operation or the second maintenance operation without replacing the printer head 22 with a new printer head 22. Thus, because a frequency of replacing, for example, the printer head 22 in which the discharge defect has occurred reduces, a time required for such a replacement operation can be saved and an operating efficiency of the printer device 10 can be improved.

In the above-described embodiment, the first maintenance operation or the second maintenance operation performed during printing is explained. However, the present invention is not to be thus limited. For example, when the ink is to be filled in the ink chamber 24a by replacing the printer head 22 with the new printer head 22, the ink can be filled, while performing the first maintenance operation or the second maintenance operation, without the foreign substances, air bubbles, etc., getting intermingled.

The time interval (approximately 80 μsec) at which the piezo element 24 is driven and the time for (approximately 2 minutes or approximately 10 minutes) performing the maintenance operation are merely examples, and the present invention is not to be thus limited. For example, when the foreign substances, etc., easily get generated due to characteristics of the ink that is used, printing conditions, etc., the foreign substances, etc., can be removed without fail by setting the time for performing the maintenance operation longer than that described above.

In FIG. 3, the printer head 22 is shown with a configuration (the ink chamber 24a formed by the piezo element 24) in which the piezo element 24 is arranged so as to come into contact with the ink stored in the ink chamber 24a; however, the present invention is not limited to this configuration. For example, the present invention is applicable to a printer head having a configuration in which the ink chamber 24a is made of a film member that is flexible and the piezo element 24 is arranged so as to come into contact with an outer side of the film member. By applying the present invention to such a printer head, the foreign substances, etc., adhering inside the film member can be separated and discharged along with the ink from the discharge nozzles 25a by causing the film member to oscillate in response to the oscillation of the piezo element 24 during the maintenance operation.

In the above-described embodiment, a configuration example of the printer device 10 of a uniaxial printing medium moving type and a uniaxial printer head moving type is explained as an example of the printer device to which the present invention is applied. However, the present invention is not limited to this configuration. The present invention can be applied to, for example, a printer device of a biaxial printer head moving type or a biaxial printing medium moving type. Furthermore, the present invention can be applied to a printer device that uses an ink of another type such as an ultraviolet curable ink.

What is claimed is:

1. A printer device comprising:
an ink tank that stores therein an ink;
a guide rail that faces a medium supporting unit that supports a printing medium, and that moves relative to the printing medium supported by the medium supporting unit in a predetermined conveying direction, and extends in a scanning direction orthogonal to the predetermined conveying direction;
a printer head that is reciprocatable relative to the guide rail in the scanning direction, and that discharges an ink from a nozzle opening that is open in a downward direction, by changing a capacity of an ink chamber, which communicates with the nozzle opening, by oscillation of an oscillating element;
an ink supply channel via which the ink chamber is connected to the ink tank;
a supply pump arranged in the ink supply channel to supply the ink stored in the ink tank to the ink chamber; and
a drive control unit that controls the oscillation of the oscillating element and drive-controls the supply pump,
wherein the drive control unit, after performing a first maintenance operation in which the drive control unit drive-controls the supply pump and controls the oscillating element to oscillate, performs a second maintenance operation in which the drive control unit drive-controls the supply pump to stop and controls the oscillating element to oscillate during maintenance of the printer head during the maintenance of the print head.

2. The printer device according to claim 1, wherein a time for continuously performing the first maintenance operation is 2 minutes or more.

3. The printer device according to claim 2, wherein a time for continuously performing the second maintenance operation is 10 minutes or more.

4. The printer device according to claim 2, further comprising a receiving member arranged near an end portion of the guide rail in the scanning direction to receive the ink discharged from the nozzle opening,
wherein the drive control unit performs the second maintenance operation after performing the first maintenance operation in a state in which the printer head is moved to the end portion of the guide rail in the scanning direction and the nozzle opening is positioned facing the receiving member with a gap therebetween to form a meniscus in the nozzle opening.

5. The printer device according to claim 1, wherein a time for continuously performing the second maintenance operation is 10 minutes or more.

6. The printer device according to claim 5, further comprising a receiving member arranged near an end portion of the guide rail in the scanning direction to receive the ink discharged from the nozzle opening,
wherein the drive control unit performs the second maintenance operation after performing the first maintenance operation in a state in which the printer head is moved to the end portion of the guide rail in the scanning direction and the nozzle opening is positioned facing the receiving member with a gap therebetween to form a meniscus in the nozzle opening.

7. The printer device according to claim 1, further comprising a receiving member arranged near an end portion of the guide rail in the scanning direction to receive the ink discharged from the nozzle opening,
wherein the drive control unit performs the second maintenance operation after performing the first maintenance operation in a state in which the printer head is moved to the end portion of the guide rail in the scanning direction and the nozzle opening is positioned facing the receiving member with a gap therebetween to form a meniscus in the nozzle opening.

8. A maintenance method for performing maintenance of a printer head that is arranged so as to be reciprocatable along a guide rail, and that discharges an ink from a nozzle opening that is open in a downward direction, by changing a capacity of an ink chamber, which communicates with the nozzle opening, by oscillation of an oscillating element, the maintenance method comprising:
a first step of moving the printer head near an end portion of the guide rail and positioning the nozzle opening facing a receiving member that is arranged near an end portion of the guide rail for receiving the ink discharged from the nozzle opening, with a gap therebetween, so as to form a meniscus in the nozzle opening;
a second step of drive-controlling the supply pump supplying ink to the ink chamber and controlling the oscillating element to oscillate such that the ink is discharged from the nozzle opening after the first step is performed; and
a third step of controlling the oscillating element to oscillate such that the ink is discharged from the nozzle opening in a state in which the supply pump is stopped after the second step is performed.
